(19) United States
(12) Patent Application Publication
(10) Pub. No.: US 2013/0053054 A1
(43) Pub. Date: Feb. 28, 2013

(54) USING PREDICTIVE TECHNOLOGY TO INTELLIGENTLY CHOOSE COMMUNICATION

(71) Applicants: Andrew William Lovitt, Redmond, WA (US); Thomas Moscibroda, Beijing (CN); Ranveer Chandra, Kirkland, WA (US); Alice Jane Bernheim Brush, Bellevue, WA (US); John Charles Krumm, Redmond, WA (US)

(72) Inventors: Andrew William Lovitt, Redmond, WA (US); Thomas Moscibroda, Beijing (CN); Ranveer Chandra, Kirkland, WA (US); Alice Jane Bernheim Brush, Bellevue, WA (US); John Charles Krumm, Redmond, WA (US)

(73) Assignee: MICROSOFT CORPORATION, Redmond, WA (US)

(21) Appl. No.: 13/216,641

(22) Filed: Aug. 24, 2011

(51) Int. Cl. H04W 24/00

(52) U.S. Cl. 455/456.1

(57) ABSTRACT

Selecting communication settings. A method includes observing at least one of present, prior, or anticipated future movement of a user. Based on the observed user movement, embodiments may predict one or more future locations of the user. Based on the one or more future locations of the user, a communication setting of a device is selected to be used by the user.

### BACKGROUND

### Background and Relevant Art

Computers and computing systems have affected nearly every aspect of modern living. Computers are generally involved in work, recreation, healthcare, transportation, entertainment, household management, etc.

Further, computing system functionality can be enhanced by a computing systems ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing system.

As alluded to, some devices may communicate using wireless technologies. Various wireless technologies have multiple frequencies that they can communicate on independently and in some examples cooperatively. Each frequency represents a communication channel. To increase bandwidth, multiple frequencies can be used as different channels to send data in parallel. Currently when a connection is made, a base station has a defined communication channel. However in peer to peer, ad-hoc, ‘future technology’ or other networks, selection of channels can be complicated. In mobile situations this is significantly more difficult due to leased spectrum space and devices moving into and out of areas where other communications are competing for the channel.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment includes a method practiced in a computing environment. The method includes acts for selecting communication settings. The method includes observing at least one of present, prior, or anticipated future movement of a user. Based on the observed user movement, embodiments may predict one or more future locations of the user. Based on the one or more future locations of the user, a communication setting of a device is selected to be used by the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates conceptual flow of data in a communication setting system;

FIG. 2A illustrates two moving entities;

FIG. 2B illustrates two moving provider entities and a static entity;

FIG. 2C illustrates two static provider entities and a moving consumer entity; and

FIG. 3 illustrates a method of selecting communication settings.

### DETAILED DESCRIPTION

Embodiments may include functionality to predict and use predictions to properly choose and switch between communication channels (or other communication settings) based on the movement and predictive placement of a device and/or user. Some embodiments may use predictive technologies to determine channels to communicate for wireless technologies. Embodiments may predict possible places that a user could be located. Embodiments may use a data store of information about the availability and quality of channels on which to communicate. This information can then be processed by a prediction engine to produce a channel or set of channels which a device could or are recommended for use for communication. Alternatively or additionally, embodiments may return a set of channels where communication is not allowed or not feasible. This could be done in a way to optimize a desirable performance metric. For example in some embodiments, this may be done to maximize connection time without switching communication channel or technology type.

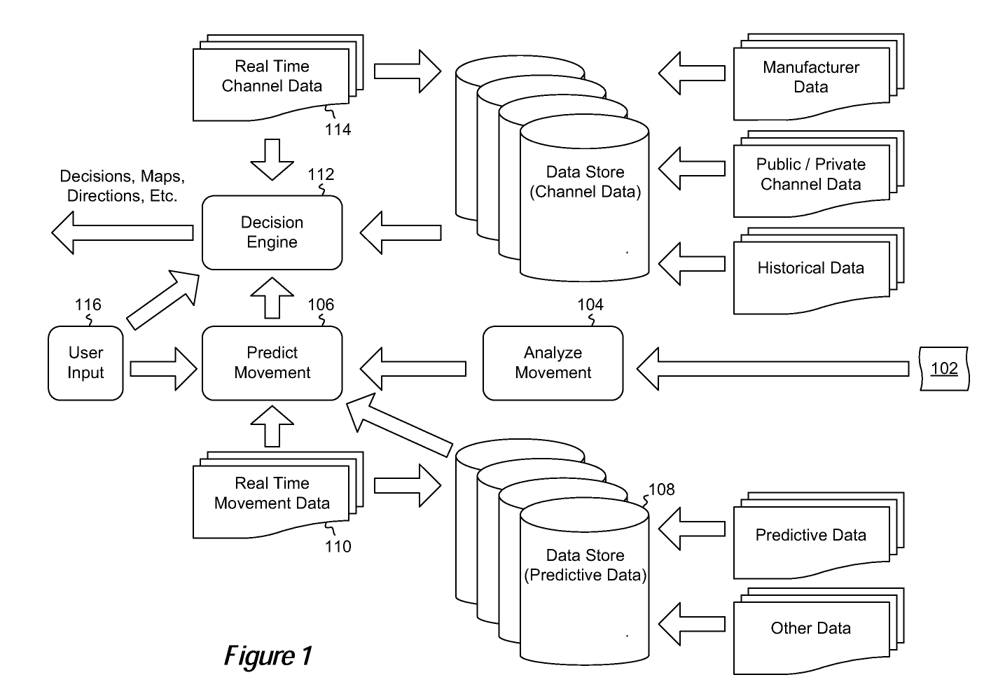

FIG. 1 shows a conceptual flow of one embodiment system. As will be discussed below, some components shown in FIG. 1 are nonetheless optional and/or alternatives within the system.

As illustrated at 104 in FIG. 1, movement data 102 is analyzed by the system. The movement data 102 could be GPS coordinates, cellular tower information, Wi-Fi network information, human input, stored history, internet routes, internet search results, etc. The movement data could be past movement, meaning movement that has already occurred, present movement, meaning moving that is presently taking place, or future movement, meaning movement that is anticipated to occur. Anticipation can be static or dynamic. For example, anticipated movement based on an electronic calendar system may be static in that it was entered by a user, while a system anticipating based on knowing frequently traveled routes may be dynamic in that the anticipation may change as habits change or as more data is collected.

As illustrated at 106, the movement data 102 is used to predict where the device will move to next. In the example illustrated, this prediction 106 uses stored data stored in a data store 108. The stored data may represent any appropriate information, such as pre-computed probability maps, points of interest, previous routes the device has taken, traffic information, other devices that are in the vicinity of the device, etc.

Illustrating one example, two devices controlled by two different users being in the same vicinity may indicate future movement. For example, two users may commonly go with each other to one or more specific locations. Thus, when two devices (such as two cell phones) are in the same vicinity (and optionally from a given starting point), there are one or more locations for which there is a high probability that the devices will move to next. More specifically, in an example scenario, a user may meet their spouse at work and then go from work to the gym. Thus, when the cell phones of the spouses come into the same vicinity while at the work of one of the spouses, there is a high probability that a future movement will be toward their gym.

The stored data may predict, or be used to predict, places, areas, or directions that a user may be going. The predict movement stage 106, in some embodiments, may incorporate real-time navigational system data 110 into the prediction 106 if it is available.

The predict movement stage 106, in some embodiments, may incorporate past movement data into the prediction 106 if it is available. For example, previous driving routes or destinations may be used. It should be noted that past movement may include past movement of a particular subject entity for which predicted movement is being performed or for a different entity, for example, one that may be representative of the subject entity.

The predict movement stage 106, in some embodiments, may incorporate future movement data 110 into the prediction 106 if it is available. For example, a user may program a destination into a navigation system. The calculated route would represent future movement. Alternatively, a user may perform an internet search for a specific location or a group of locations. The results of the search may represent anticipated future movement. As will be discussed in more detail below, information about searches can be provided to a system by network connections. For example, a system in an automobile may be connected to a home network, which would allow a computer on the home network to provide information about Internet search results to the system in the automobile.

Data from the prediction 106 is fed into the decision engine 112 which will combine the information 114 about communication channels that the system may (or may not) use. This data can be positive data (where the channel is available), negative data (where the channel is not available), what the quality of the channel is (how well the channel propagates), historical data from the device of what worked, historical data of what other devices have succeeded in using, historical data of which channels are likely crowded by other users, weather conditions, terrain data, etc. or a combination thereof. The decision engine 106 can make decisions based on the output the system is suppose to output. This could be but is not limited to: a single channel to communicate on, a set of possible channels, a listing of the best channels to the worst, a list of poor or disallowed channels to use, maps representing the regions available for certain channels, maps representing the regions for a set of channels, an indication of channels that cannot or should not be used, etc.

Optional user input 116 can influence the system. This optional user input 116 can take many forms as mentioned above and can influence any aspect of the system. For instance the user may select a channel from a list, exclude a channel or communication technology from being considered, input route information, input schedules (such as in an electronic calendaring system), etc

As illustrated above, an in more detail below, embodiments may be implemented which use predictive algorithms to select channels for peer to peer (P2P), Ad-Hoc, and Fixed Point Communications. Various factors may be used when using predictive algorithms to select channels. For example, predictive algorithms may be used to select channels based (or augmented by) one or more of the following: quality of communication; availability of communication; probabilistic models of channel usage (for any protocol in use or not in use); user input including navigational engine paths, routes, or other information; previous user interactions with the device or other devices; from the internet, updates, upgrades, etc.; and/or historical information collected by the device or other devices.

As shown, predictive technology can be used to improve channel selection and channel usage in wireless communication scenarios. Embodiments may enable devices to be able to use probability maps and data generated from various sources, including information such as current and historical positions of the device and/or information generated from collections of large amounts of data (like historical traffic patterns for channel congestion), etc., to appropriately select a channel to communicate using a wireless communication protocol. One example of a predictive algorithm which may be used in some embodiments is set forth in a presentation titled “Inferring Destinations from Partial Trajectories” available in the report of the Eighth International Conference on Ubiquitous Computing (UbiComp 2006) held in 2006 in Orange County, California on pages 243-260 of the report. These pages of the report are incorporated herein by reference in their entirety.

Various protocols may be used. For example, in some embodiments, whitespace channel selection may be used. In particular, whitespace channels represent network bandwidth in the VHF and UHF TV band spectrum that is currently unused by TV broadcasters and other primary users of the spectrum. In the United States, such whitespace channels have recently been made available for unlicensed use for opportunistic wireless networks. In other words, the spectrum vacated by broadcasting stations is now available for use for other communication devices, where such spectrum is commonly referred to as whitespace. However, digital TV stations and certain licensed wireless microphones still occupy portions of the VHF and UHF TV band spectrum. Thus, certain portions of this spectrum are still being used, and are not available for secondary, opportunistic wireless communication devices. Specifically, in areas where these stations are broadcasting, users are prevented from using occupied spectrum by FCC rules. Hence, different portions of this spectrum may be available at different locations. Thus, embodiments could take into account occupied spectrum space when determining channel selection usage.

In alternative or additional embodiments, applications may be applied to mobile Wi-Fi points. Embodiments may enable more efficient channel selection for ad-hoc and peer to peer networks. Alternatively or additionally, embodiments may inform, maintain, and/or expand fixed point communication points.

Some embodiments may be implemented in a system where at least one endpoint is mobile. Some embodiments may control channel selection to minimize interruption to the connection (or to maximize the quality of the connection) based on the prediction. This prediction can be generated based on various including one or more of (but not limited to): pre-generated maps based on traffic data; pre-generated maps based on user or device history; pre-generated maps from external sources; pre-generated maps based on signal propagation modeling; real-time generated maps from point of interest data; real-time generated maps from historical data (user, device, company, etc.); maps downloaded from the internet; maps brought into the car through a phone, USB key, etc.; updated through any update mechanism; routing information from a navigation unit; etc. Note that map in this context is not necessarily limited to 2-D traditional maps. Alternatively or additionally, a ‘map’ may refer to a 3-D map and databases with geospatial information stored in any way, or other types of maps.

The prediction calculated at 106 may inform the decision engine 112 on how to evaluate channels. In one embodiment, informing the decision engine may include transferring a probability map where each point represents the probability that the device is anticipated to occupy that point at some future time. Additionally a set of maps may be sent where each specifies the map for a specific range of times. The decision engine 112 may incorporate data from one or more of a number of different sources. For example a combination of one or more of the following (non-limiting) examples may be used: where the channel cannot be used; where the channel can be used; the level of fidelity the channel provides; effects of time on the channel (afternoon vs. early morning); historical patterns for channel usage; historical patterns for other users using a channel; measured or estimated quality of the channel (i.e. throughput, noise-level, degree of interference, packet loss, etc.); etc.

The decision engine 112 can then make a decision. The decision could be, for example, one or more of: a list of channels possible to use; a single channel to use (possibly with a list of priorities attached to the different channels); a map for each channel specifying where that channel can be used; etc. This can then be used by the system to make switching and usage decisions.

The decision engine 112 and movement prediction engines 106 can be augmented and/or controlled through user input. For (non-limiting) example, such user input may include: navigational unit route information; user confirmation of channel selections; user inputted (shapes, points, etc.) indicating the path or region the user is traveling to; information from social networks and internet websites/databases; voice interactions with the device to indicate or influence any aspect of the scenario; selecting which maps and data to download and which to not download; selecting which data stores to use and which to exclude in general or for specific time frames; etc.

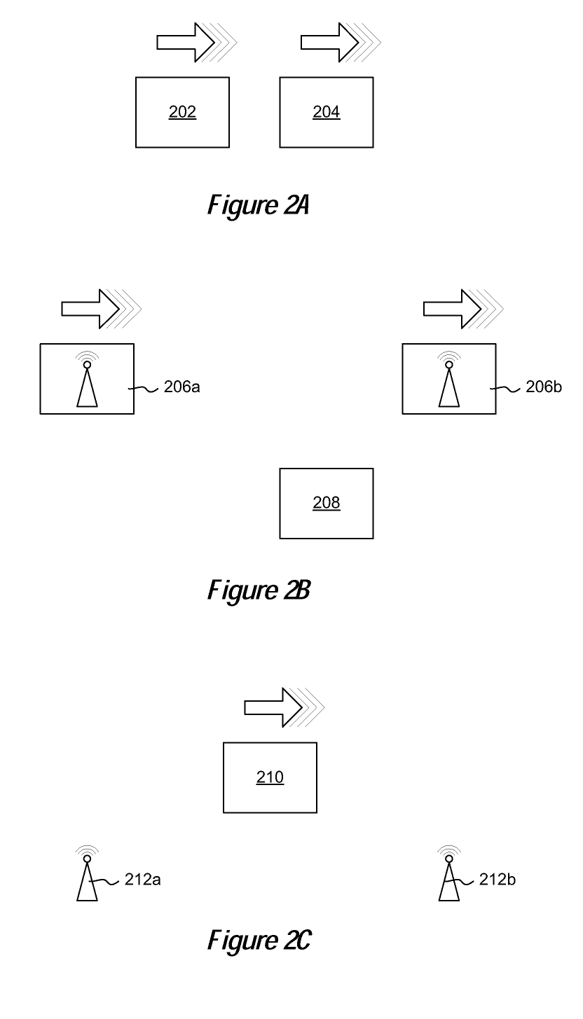

Various different embodiments may be implemented. FIGS. 2A-2C illustrates various examples. FIG. 2A illustrates an example where two entities 202 and 204 are both moving. The two entities 202 and 204 may wish to communicate with each other. Channel selection, or other communications settings, for the two entities 202 and 204 to communicate with each other may be based on the movement of the two entities 202 and 204 (or other entities). Concrete examples of the example illustrated in FIG. 2A may include P2P communications between two automobiles traveling together.

In an alternate example, one of the entities may be a service consumer whereas the other entity is a mobile service provider. For example, entity 202 may be a private vehicle traveling on a highway whereas entity 204 is a commercial vehicle with network provider hardware (such as a mobile hot spot) traveling on the same highway. Alternatively, entity 204 may be a mobile satellite or other aerial service provider system.

FIG. 2B illustrates an example where service provider entities 206a and 206b are moving whereas a service consumer entity 208 is static. While only two service provider entities are illustrated, it should be appreciated that a string of service provider entities could be used. In this example, embodiments may determine communication settings, such as channel selection, based on the movement of the service provider entities 206a and 206b. It should be noted that different service provider entities will not necessarily select the same settings with respect to the service consumer entity 208. For example, an algorithm may be selected to minimize the number of channel changes and thus if different service provider entities take different geographical paths different channels may be selected than if the service provider entities were taking the same path.

Various examples of embodiments conforming with the example in FIG. 2B are now illustrated. In one example, the static service consumer 208 may include an automobile parked at a rest area on a highway. One or more of the service providers 206a and 206b may be commercial vehicles, such as tractor-trailer vehicles, that act as mobile service providers. In an alternative, or additional, example one or more the service providers 206a and 206b may be a satellite or other aerial service provider.

FIG. 2C illustrates yet another example. In this example, a consumer entity 210 is mobile whereas provider entities 212a and 212b are static. Communication setting selection (e.g. channel selection) may be based on the movement of the consumer entity 210.

The following now illustrates a number of specific, non-liming, scenarios. In one example, two cars are used for a road trip and the users would like to interact with each other during the trip. The cars are both communicating over white space spectrum. After the lead car inputs the route for the trip the car decides which channel (or generally, which part of the spectrum) has the longest free fidelity on the route chosen and communicates to the other car over that channel. The cars then connect and the route and information is sent to the second car and the connection is managed through this connection. As the cars are traveling the channel is switched after 50 minutes because the channel will no longer be available in 5 minutes due to FCC regulations. The cars both switch over long before they cannot use that channel anymore and the communication between the cars continue.

In a continuing example, as the traveling cars in the example approach a large city on their road trip the lead car knows that the driver likes a certain fast food restaurant. The lead car then factors this preference into its decision about which channel to communicate on. Thus when the lead car enters the city and is required to switch channels, the lead car selects a channel on which it can continue to communicate with the following car even if the driver pulls into the restaurant a short way off the planned route. Therefore when the driver does make a diversion for food the connection does not need to change channels because the channel was chosen with this possibility in mind.

Still further continuing the above example, as the lead car is traveling it enters a steep canyon. The car knows that the car will continue out to the other side of the canyon and the channel is still free. However the canyon's geography offers poor quality for the current communication channel and better quality on a second channel. The car also knows that a third channel can provide perfect connections for the entire length of the canyon however the rest stop in the middle uses this third channel. In this case the car may choose the 2nd channel as this would be an uninterrupted channel for the length of the canyon.

Illustrating now another example, a worker uses the bus every morning to get to work. His/her phone is connected to the internet via a whitespace communication protocol. The device knows that the user travels the same path to work every day and so chooses the channel for communication that is able to utilized the entire way. This way the device always has connectivity without hopping channels.

Illustrating yet another example, a driver gets into an automobile and does not input the route that the driver plans on driving. However the traffic patterns for that time of day show that most users from his current location and current direction typically turn onto the interstate in 3 miles. The FCC has required that certain channels are the only channels available on high-ways but has made no ruling on the channels for use in the side-streets. The car predicts the user will get on the highway, and thus, the car will choose to communicate through one of the channels available on the highway.

Illustrating yet another example, a user in one automobile would like to communicate with a user in another automobile. The device predicts possible destinations for the device. The device then decides that there are three possible channels to use. The device presents to the user a map with three overlays which show the areas where that channel is available to use for communication. The user then manually selects the channel to communicate on.

Illustrating yet another example, a device makes a prediction about where a user will go, but the prediction is necessarily more uncertain for distances farther away from the user's current location. Instead of trying to find an optimal channel sequence for the entire trip, the prediction defers some decisions for later, knowing that it will have less uncertainty at the later time and thus a better ability to optimize the channel selections. As a concrete example, there may be a branch point in the user's route where he/she is predicted to either turn north or south onto a major highway. After the user makes this choice, the prediction becomes much more certain of the user's future path. Channel selection decisions can be deferred until more certainty is obtained. Alternatively or additionally, channel selection decisions can be continually changed.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

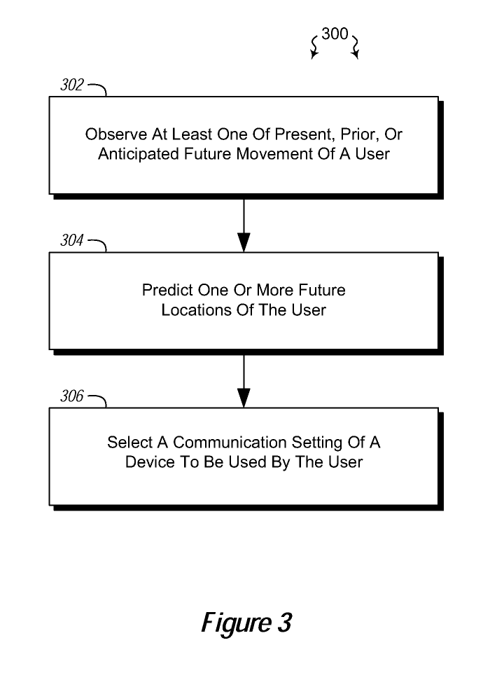

Referring now to FIG. 3, a method 300 is illustrated. The method 300 may be practiced in a computing environment. The computing environment is not necessarily a desktop computing environment, but rather an environment where computing hardware may be used to perform various method acts. The method 300 includes acts for selecting communication settings. The method 300 includes observing at least one of present, prior, or anticipated future movement of a user (or service provider) (act 302). For example, embodiments may observe movement of a user that is currently taking place. This could be done by monitoring GPS signals which show current movement. Alternatively, this may be done by monitoring movement through different cells on a cellular system. Alternatively, this may be done by monitoring a user's use of different Wi-Fi hotspots. Alternatively, this may be done monitoring radio or other tracking devices.

Observing prior movement may be done using similar types of tools. Observing future movement may be done using navigation directions, for example, results of internet searches, observations in personal calendars, etc.

Illustrating now an example list that is not intended to be exhaustive, monitoring of present, past or future movement may be performed by observing at least one of a GPS reading, cellular tower, wireless network, odometer reading, accelerometer reading, light sensor reading, checkpoint updates (such as data collected by toll booths) license plate scan, electronic calendar entry, internet search results, or internet search history, gyroscope, camera, radio beacon, RFID, written record, check-in data, credit card records, etc.

The method 300 further includes, based on the observed user movement, predicting one or more future locations of the user (or service provider) (act 304). For example, the system may be able to attempt determine where a user will be in the future based on other movement data. For example, if a user has typed an address into a GPS system, the system can determine that the user will likely be at the location typed into the GPS. It should be noted that a future location may be a location where a user already is located. For example, if a user checks into a hotel at 9:00 P.M., there is a high probability that the user will remain at the hotel for several hours.

In some embodiments, predicting may include referencing a pre-generated map. For example, the pre-generated map include one or more of a map based on traffic data, a map based on user or device history, a road map showing developed travel routs, or a map based on signal propagation modeling. Illustratively a map may have street level detail. Additionally data may be associated with the map which includes speed limit information. Based on this information, predictions can be made about a users planned route. This can help to determine a user's likely location at some future point in time.

Some embodiments may be practiced where predicting includes referencing a real-time generated map. In some embodiments, the real-time generated map may include a map based on point of interest data and/or a map based on historical data. For example, a map may have real time traffic data. The traffic data may be used to predict a likely future location. This can be done for example by noting high traffic on one route as compared to another route and thus determining that a user is more likely to take the higher traffic route because historically that is what most travelers do.

The method 300 further includes based on the one or more future locations of the user (or service provider) selecting a communication setting of a device to be used by the user (or service provider) (act 306). Selecting a communication setting can include any of a number of different actions. For example, in one embodiment, selecting a communication setting of a device to be used by the user includes selecting a communication channel. In an alternative or additional embodiment, selecting a communication setting of a device to be used by the user comprises selecting a base station. In yet another alternative or additional embodiment, selecting a communication setting may involve selecting or change a communication mode (e.g. moving from whitespace channels to Wi-Fi channels).

In some embodiments predicting is performed to cause a setting to be selected resulting in a minimization of subsequent setting reconfigurations. For example, embodiments may determine that different communication channels should be used along a route. However, embodiments may attempt to minimize the number of changes and thus select channels in a way that requires fewer changes.

In some embodiments predicting is performed to cause a setting to be selected resulting in a maximization of connectivity to a given channel prior to switching to a different channel. For example, embodiments may be implemented to find a channel that would allow for longer connection times using that channel between channel switches.

In some embodiments predicting is performed is performed to cause a setting to be selected resulting in a minimization of the number of channels used for communication over a communication period. For example, embodiments may be implemented to attempt to use the least number of channels or the least number of channel switches. The communication period may be a period of time, a period of distance, or a period of a route.

In some embodiments predicting is performed to cause a setting to be selected resulting in a minimization of cost for channel usage. For example, there may be a monetary cost associated with using some channels (for example, roaming costs or other costs). Embodiments may be implemented to allow for selecting lower cost channels.

In some embodiments predicting is performed to cause a setting to be selected resulting in a maximization of power available for communicating on a channel. For example, some channels allow more power to be used to allow for communication between devices over a greater distance on a given channel or to reduce incidences of errors. Illustratively, when a channel being used is a whitespace channel created due to vacating television RF space, the channels may have limits based on what adjacent television channels are still operating. Thus, by selecting a channel that has no directly adjacent channels with television signals still operating on them, higher power can be used for the whitespace channel.

In some embodiments predicting is performed to cause a setting to be selected balancing geospatial coverage with user movement uncertainty. In particular, an exact future location may not be known, but rather predicting can include predicting a plurality of possible locations. Locations can be eliminated over time as movement is observed.

Further, the methods may be practiced by a computer system including one or more processors and computer readable media such as computer memory. In particular, the computer memory may store computer executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, a method of selecting communication settings, the method comprising:
observing at least one of present, prior, or anticipated future movement of a user;
based on the observed user movement, predicting one or more future locations of the user; and
based on the one or more future locations of the user selecting a communication setting of a device to be used by the user.

2. The method of claim 1, wherein selecting a communication setting of a device to be used by the user comprises selecting a communication channel.

3. The method of claim 1, wherein selecting a communication setting of a device to be used by the user comprises selecting a base station.

4. The method of claim 1, wherein observing at least one of present, prior, or anticipated future movement of a user comprises observing at least one of a GPS reading, cellular tower, wireless network, odometer reading, accelerometer reading, light sensor reading, gyroscope reading, camera data, radio beacon reading, RFID reading, a written record, check-in data, credit card records, a checkpoint update, presence of another device, an electronic calendar entry, internet search results, or internet search history.

5. The method of claim 1, wherein predicting comprises referencing or using a pre-generated map.

6. The method of claim 5, wherein the pre-generated map comprises one or more of a map based on traffic data, a map based on user or device history, a map based on geography, a roadmap showing possible defined routes, or a map based on signal propagation modeling.

7. The method of claim 1, wherein predicting comprises referencing a real-time generated map.

8. The method of claim 6, wherein the real-time generated map comprises one or more of a map based on point of interest data or a map based on historical data.

9. The method of claim 1, wherein predicting is performed to cause a setting to be selected resulting in a minimization of subsequent setting reconfigurations.

10. The method of claim 1, wherein predicting is performed to cause a setting to be selected resulting in a maximization of connectivity to a given channel prior to switching to a different channel.

11. The method of claim 1, wherein predicting is performed to cause a setting to be selected resulting in a minimization of the number of channels used for communication over a communication period.

12. The method of claim 1, wherein predicting is performed to cause a setting to be selected resulting in a minimization of cost for channel usage.

13. The method of claim 1, wherein predicting is performed to cause a setting to be selected resulting in higher power being available for communicating on a channel to increase transmission distance or to reduce errors.

14. The method of claim 1, wherein predicting is performed to cause a setting to be selected balancing geospatial coverage with user movement uncertainty.

15. In a computing environment, a method of selecting communication settings, the method comprising:
observing at least one of present, prior, or anticipated future movement of a service provider;
based on the observed provider movement, predicting one or more future locations of the provider; and
based on the one or more future locations of the provider selecting a communication setting of a device to be used by the provider.

16. The method of claim 15, wherein selecting a communication setting of a device to be used by the service provider comprises selecting a communication channel.

17. The method of claim 15, wherein observing at least one of present, prior, or anticipated future movement of a service provider comprises observing at least one of a GPS reading, cellular tower, wireless network, odometer reading, accelerometer reading, light sensor reading, gyroscope reading, camera data, radio beacon reading, RFID reading, a written record, check-in data, credit card records, a checkpoint update, an electronic calendar entry, internet search results, or internet search history.

18. The method of claim 15, wherein predicting is performed to cause a setting to be selected resulting in a minimization of subsequent setting reconfigurations.

19. The method of claim 15, wherein predicting is performed to cause a setting to be selected resulting in a minimization of the number of channels used for communication over a communication period.

20. A system for selecting communication settings, the system comprising:
an analyzing module configured to observe at least one of present, prior, or anticipated future movement of a device;
a movement prediction module configured to predict one or more future locations of the device, based on the observed device movement; and
a decision engine configured to select a communication setting of the device based on the one or more future locations of the device.
